(19) United States
(12) Patent Application Publication
(10) Pub. No.: US 2010/0295291 A1
(43) Pub. Date: Nov. 25, 2010

(54) SHEET INCLUDING AT LEAST ONE WATERMARK OR PSEUDO-WATERMARK THAT IS OBSERVABLE FROM ONLY ONE FACE OF THE SHEET

(75) Inventors: Sandrine Rancien, La Murette (FR); Alban Remy, Provins (FR); Michel Camus, Rives Sur Fure (FR); Pierre Doublet, Saint-Brice (FR); Manuel Deloche, Serris (FR)

Correspondence Address: OLIFF & BERRIDGE, PLC, P.O. BOX 320850, ALEXANDRIA, VA, 22320-4850, US

(73) Assignee: ARJOWIGGINS SECURITY, Paris (FR)

(21) Appl. No.: 12/682,645

(22) PCT Filed: Oct. 9, 2008
(86) PCT No.: PCT/FR08/51832

§ 371 Date: May 25, 2010

(30) Foreign Application Priority Data
Oct. 12, 2007 (FR) 07 58299
Jun. 24, 2008 (FR) 08 54202

(51) Int. Cl. B42D 15/00; B44F 1/06

(52) U.S. Cl. 283/113; 428/29

(57) ABSTRACT

The invention relates to a sheet having a recto face and a verso face together with at least one watermark or pseudo-watermark and such that at least part of said watermark or pseudo-watermark is observable in transmitted light from only one of the faces of said sheet.

The present invention relates to a sheet including at least one watermark or pseudo-watermark and it also relates to an article, in particular a security document, that comprises said sheet.

In order to protect against counterfeiting or falsifying security documents such as payment means such as bank notes, checks, or official documents, in particular identity documents such as passports, identity cards, or tickets for entry to cultural or sporting events, or transport tickets, it is possible to use a variety of security means such as watermarks that enable a document to be authenticated by being observed in transmitted light. In addition, such watermarks provide protection against copying by optical means such as photocopying, photography, or scanning, since the medium used for the copy does not include the incorporated watermark.

Watermarks are also used for decorative and prestige purposes, in particular for printing/writing papers, in particular for letterheads, or art paper, such as paper for watercolors.

Watermarks in sheets of paper are conventionally obtained during the wet stage of fabrication of the sheet by depositing paper pulp on an embossed fabric of a paper machine, so that the quantity of pulp that is deposited is greater in the recesses of the embossing and smaller in the projections of the embossing compared with the remainder of the paper, thereby creating differences in opaqueness, the zones having the greatest density of pulp appearing darker and the zones having lower density appearing paler, compared with the rest of the sheet (the “velum” portion) when the sheet (after drying) is observed in transmitted light. That technique relates to fabricating paper on a cylinder mold paper machine. Such watermarks present different levels of gray depending on the relief on the embossing and they are said to be multi-tone watermarks.

Watermarks may also be made by embossing a wet sheet with a watermarking roll (also known as a “dandy roll”) on a flatbed fourdrinier machine.

Another technique that is known for fabricating paper with watermarks that present a multi-tone effect is described in patent application EP-A-1 122 360, and comprises creating paler zones (of density per unit area less than that of the velum zone of the sheet) that are arranged to form a silkscreen image in the sheet, and that are obtained with the help of a set of masks fastened to the draining fabric of the paper machine.

In patent application FR 06/50470, a sheet material is described that comprises at least a first layer defining an outside face of said material and presenting at least a first color, and at least a second layer including at least one watermark and presenting at least a second color, the first and second layers having at least different saturations and/or hue angles. That produces watermarks that are colored and visible through the material.

It is also known to make pseudo-watermarks on a sheet of appear. Pseudo-watermarks reproduce the appearance of a watermark by presenting differences of opaqueness. Such pseudo-watermarks may be obtained mechanically by applying pressure, with or without application of heat, and/or chemically by applying a composition, e.g. by locally increasing the transparency of the paper by using substances for making it more transparent. The density of the fiber material between the paler zones and the darker zones of a pseudo-watermark may be uniform, unlike a conventional watermark.

There exists a need to propose novel security measures against falsification for security documents and sheets, which measures are easily observable for the man in the street, while presenting a satisfactory level of security.

There also exists a need to have watermarked or pseudo-watermarked paper available in the field of fine or art paper and/or printing/writing paper presenting a novel appearance effect that may also contribute, where appropriate, to authenticating the paper.

In order to satisfy the above-specified needs, the present invention proposes a sheet having a recto face and a verso face and at least one watermark or pseudo-watermark, the sheet being such that at least part of said watermark or pseudo-watermark is observable in transmitted light from only one of the faces of said sheet.

More particularly, the invention provides a sheet having a recto face and a verso face and comprising:
a first layer including at least one first watermark or pseudo-watermark; and
a second layer including at least one second watermark or pseudo-watermark, said sheet being such that at least part of said first watermark or pseudo-watermark is observable in transmitted light, from only the recto face of the sheet, and at least part of said second watermark or pseudo-watermark is observable in transmitted light from only the verso face of the sheet.

Each of the watermarks or pseudo-watermarks is therefore observable in transmitted light, at least in part, only when looking at the respective layer that includes the mark. The watermarks or pseudo-watermarks, or at least parts thereof, are not clearly observable simultaneously in transmitted light from either side of the sheet.

The sheet of the invention preferably includes at least one light-diffusing and translucent interlayer referred to as the “diffusing layer”, situated between the first and second layers. The term “translucent” is used to mean that the material of the layer allows sufficient light to pass therethrough to be able to see through the layer.

The interlayer is advantageously such that at least part of the first watermark or pseudo-watermark is observable in transmitted light and in register with the interlayer, only from the recto face of the sheet and at least part of the second watermark or pseudo-watermark is observable in transmitted light and in register with the interlayer only from the verso face of the sheet.

By means of the invention, it is possible to prevent the watermarks or pseudo-watermarks of the two layers combining together, in particular because of the presence of the interlayer. Without the presence of the interlayer in register with the watermarks or pseudo-watermarks, it would be possible for the watermarks or pseudo-watermarks to be combined.

At least parts of the watermarks or pseudo-watermarks of the two layers may be superposed one on the other, in particular in register with the interlayer. In particular, the watermarks or pseudo-watermarks may be completely superposed one on the other. In a variant, the watermarks or pseudo-watermarks need not be superposed one on the other, for example they may be disjoint or side by side.

### Watermark or Pseudo-Watermark

In the invention, the term “watermark or pseudo-watermark” is used to mean a drawn image that appears in the thickness of the sheet, in particular in the thickness of the first layer or the second layer.

The watermark or pseudo-watermark may be made in various ways known to the person skilled in the art, e.g. in a fiber or polymer layer.

The watermark may be a design etched or pressed into a fiber layer during fabrication. By way of example, such a watermark is visible in transparency by creating zones of pulp that are of reduced or increased thickness at the time the fiber layer is being fabricated on a cylinder mold paper machine, with this being achieved by a projecting or setback imprint in the forming fabric of the cylinder mold.

The watermark may also come from zones in which the fiber layer has been pressed against a flatbed fourdrinier machine by a watermarking roll that includes the watermark etched in relief, thereby having the effect, while the fiber layer is being formed in the wet portion of the machine, of strongly pressing certain zones of the fiber layer and thus expelling the water contained in the fibers.

The pseudo-watermark may be produced in a finished fiber layer by mechanical and/or chemical means by applying certain substances, the design still being visible in transparency.

By way of example, the pseudo-watermark may be made by placing or printing a composition in determined zones of the fiber layer, which composition modifies the transparency of the fiber layer, in particular in order to provide zones that are pale and zones that are dark, similar to those of a watermark, but without obtaining a result that makes it possible to obtain fineness and variations of shade that are comparable with those of a conventional watermark.

For example, it is possible to make the finished fiber layer more transparent by applying e.g. a generally fatty composition to determined zones thereof, which composition makes the fiber layer more transparent in permanent manner, such as for example a composition made up of oil and a transparent mineral material as described in U.S. Pat. No. 2,021,141, or for example a composition in the form of a wax combined with a solvent, as described in U.S. Pat. No. 1,479,337.

It is also possible to make the finished fiber layer more transparent by locally applying a wax by hot transfer as described in U.S. Pat. No. 5,118,526, a fluid transparentizing composition that is polymerizable under irradiation as described in GB 1 489 084, or a composition based on polyether, aliphatic isocyanate, and alcohol, that is applied by printing, as described in DE 3 920 378.

It is also possible to use a fiber layer including a hot-melt material, such as for example polyethylene, as descried in patent EP 0 203 499, which, under the local action of heat, is subjected to variations of transparency.

The finished fiber layer may be made more opaque, while nevertheless not being made completely opaque, by applying an opacifying agent in determined zones to increase the opacity of the fiber layer, e.g. as described in patent application FR 2 353 676. By way of example, the opacifying agent may be an aqueous suspension of a pigment or of a filler or a solution of a chemical composition, of a colored composition, or of a dye. The agent may be applied on the first sheet while fabricating the fiber layer and before it is removed from the fabric, so that the agent penetrates into the interstices of the sheet and gives rise, after drying, to a modification of the opacity of the sheet for treatment in selected zones. That fabrication technique has the drawbacks of requiring special roll devices for applying the agent, and, for better results, of requiring a suction device to be used in order to cause the agent to penetrate into the interstices of the sheet.

It is also possible to make a pseudo-watermark using the method described in the document by W. Walenski, “Watermarks and those that are not”, Druckspiegel 52, No. 3: 66-68 (March 1997). That document describes a method of fabricating a pseudo-watermark on non-coated paper, the method including applying a marking piece representing the pattern of the pseudo-watermark with heat and pressure against a sheet of re-wetted paper.

It is also possible to make a pseudo-watermark on non-coated paper by applying a re-wetting solution on one or more determined zones of the paper with heat and pressure so as to evaporate the solution and densify the paper in the determined zones.

International application WO 97/17493 also describes fabricating coated paper including pseudo-watermarks that result from a varying in the weight of the layer that is applied in determined zones, thereby giving rise to a variation in the thickness and the opacity in these zones where the weight of the coating is reduced or increased.

International application WO 99/014433 also describes another method of fabricating a pseudo-watermark on coated paper, that method involving making an image in the paper after the drying step that follows the last coating operation, by performing steps in which a re-wetting solution is applied to at least one face of the coated paper in one or more determined zones, and pressure and heat are applied in those zone(s) of the coated paper so as to evaporate the solution and densify the coated paper therein relative to the remainder of the paper.

Finally, a pseudo-watermark may be made mechanically by making marks by mechanical embossing in determined zones of the fiber layer, as described in patent DE 3 718 452.

A pseudo-watermark may also be made in a polymer layer by applying a composition suitable for modifying its transparency.

Application WO 91/07285 describes printing a composition on a synthetic medium, which composition modifies the opacity of the support and contains at least one mineral filler and at least one binder and a soluble or pigmentary coloring agent. The composition is applied in determined zones and the medium is subsequently coated over its entire surface with a printable pigmentary composition using coating methods known to the person skilled in the art.

U.S. Pat. No. 4,307,899 describes an authentication card comprising an imprint formed on a medium, preferably a plastics medium, by printing partially superposed colored layers. The zones printed with a single layer appear pale in transmitted light and dark in reflected light, and the zones printed with a plurality of superposed layers appear dark in transmitted light and pale in reflected light, thereby producing a watermarked effect. By modifying the number of layers, it is possible to obtain multi-tone effects.

A pseudo-watermark may also be made in a polymer layer by using mechanical means.

For example, it is possible to make a pseudo-watermark on a sheet of polymer material by passing the sheet between two rolls, one of which carries a recessed or projecting pattern in relief so as to form an impression as described in EP 0 655 316. The sheet is subsequently oriented by being stretched so that in transmitted light the pattern appears in black and white corresponding to the zones that are marked in projection or depression by the roll.

International application WO 2007/016148 also describes a plastics layer suitable for being deformed, in particular stamped by embossing or debossing to form an image that appears like a watermark, and then laminated without the image that has been formed being damaged.

Finally, a pseudo-watermark may be made on a polymer layer by using electromagnetic radiation, for example a laser.

For example, application EP 1 518 661 describes a method of making a pseudo-watermark on a reeled polymer sheet by electromagnetically irradiating certain zones and by stretching the sheet so to obtain a stretched sheet presenting transparent zones that correspond to the irradiated zones.

The watermarks or pseudo-watermarks of the first and second layers may be made using any of the above-described methods.

One of the layers may include a watermark and the other a pseudo-watermark, or both layers may have respective watermarks or both may have respective pseudo-watermarks.

The interlayer may comprise a single layer or a plurality of layers.

The interlayer may be a polymer layer or it may include one or more polymer layers.

In a preferred embodiment of the invention, the polymer layer may be in the form of a film. The film may optionally be a foam film. By way of example, the polymer film may comprise a film of polyvinyl chloride (PVC), of polyethylene terephthalate (PET), of polycarbonate (PC), of polyester carbonate (PEC), of polyethylene terephthalate glycol (PETG), of acrylonitrile butadiene styrene (ABS), or a light-collecting film, e.g. of the “waveguide” type, e.g. a luminescent film based on polycarbonate and sold by the supplier Bayer under the name Lisa®.

The interlayer may also be a fiber layer or may comprise one or more fiber layers.

By way of example, the fiber layer may be based on cellulose fibers, in particular cotton fibers, and/or synthetic fibers such as polyamide and/or polyester fibers, for example. In particular, the interlayer may be a translucent tracing paper.

The first layer and/or the second layer may be fiber or polymer layers.

In a particular embodiment of the invention, the first layer and/or the second layer are fiber layers, in particular based on cellulose fibers, in particular cotton fibers, and/or synthetic fibers, such as polyamide and/or polyester fibers, for example.

In another particular embodiment of the invention, the first layer and/or the second layer are polymer layers, in particular as described above. In particular, the first layer and/or the second layer may be polymer layers provided with cavities and/or mineral fillers so as to make them partially opaque. The first and/or second layer may be coextruded, being made from at least one polymer material, and may include a core layer together with at least one skin layer, the core layer including voids. The “core layer” corresponds to a base layer further from the surface of the first layer or the second layer than the “skin layer” that corresponds to a surface layer. The first layer and/or the second layer may in particular be made as described in applications EP 0 470 760 and EP 0 703 071. For example, for the first and/or second layer it is possible to use a film based on bi-stretched polyethylene sold under the name Polyart® by the supplier Arjowiggins, or a silica-filled polyethylene film sold under the name Teslin® by the supplier PPG Industries. Under such circumstances, the first and second layers may each have a pseudo-watermark, e.g. made by using a laser, by stretching, and by coating with a printability layer, as described in EP 1 518 661.

In a preferred embodiment of the invention, the interlayer may be a polymer layer that has previously been extruded or laminated onto the first and second layer(s), e.g. extruded hot or cold. By way of example, for the extruded polymer, it is possible to use polyethylene or a mixture of polyethylene and ethylene vinyl acetate.

The interlayer may also be previously impregnated or coated on the first and second layer(s). This layer may comprise a translucent chemical compound, e.g. a dispersed polymer coming from a polymer put into an aqueous dispersion (latex), in particular an acrylic polymer, e.g. a hydrosoluble polymer, in particular a polyvinyl alcohol or, for example, a polymer foam (i.e. a composition including bubbles of gas, in particular of air).

The interlayer may be assembled with the first and second layers with the help of one or more adhesive layers that are in liquid form or in film form. In a variant, the interlayer may be assembled to the first and second layers by melting or welding.

The interlayer may also be or include an adhesive layer, e.g. an adhesive film suitable also for serving to assemble together the first and second layers. The adhesive film may for example be a polyethylene film.

In a particular embodiment, the interlayer may be previously sized on at least one of its faces with an adhesive composition that is sensitive to pressure or reactivatable when hot, the composition being applied cold or hot, in liquid form, by extrusion or by lamination.

In another particular embodiment, the inside faces of the first and second layers may be previously sized with an adhesive composition that is sensitive to pressure or reactivatable when hot, the composition being applied cold or hot, in liquid form, by extrusion or by lamination.

The light-diffusing nature of the interlayer may come from the refractive index of the interlayer, from its composition, from its thickness, and/or also from its surface irregularities.

In a particular embodiment, the surface irregularities of the interlayer may be obtained by embossing or graining said surface. The surface irregularities may also be obtained by irregularities of the surface that support the layer, as applied for example with an interlayer of polymer extruded onto the surface of a fiber first layer.

In another particular embodiment, the interlayer is a layer including cavities that impart a diffusing nature thereto, e.g. bubbles.

In another particular embodiment of the invention, the interlayer is a layer including a diffusing filler selected in particular from mineral pigments, in particular kaolin or titanium dioxide, and organic pigments, in particular beads of polystyrene or of polyurethane.

The thickness of the interlayer may be different from the thickness of at least one of the first and second layers. The interlayer may also present a width and/or a length that differ from, in particular that are smaller than, the width and/or length of at least one of the first and second layers.

The interlayer may extend over the entire surface area of the first and second layers.

In a particular embodiment of the invention, the interlayer is partial in the sense that it extends over only a part of the surface area of the first and second layers of the sheet. Under such circumstances, the interlayer preferably extends over an area of the first and second layers that is sufficient to cover the watermarked or pseudo-watermarked portions of said layers.

In another particular embodiment of the invention, the interlayer extends over a portion of the sheet, preferably from one edge to the other of the sheet, in a zone that is in register with at least one watermark or pseudo-watermark, e.g. so as to form a strip.

In a particular embodiment of the invention, the interlayer is partial in the sense that it extends over a part only of the surface area of at least one of the watermarks or pseudo-watermarks. Thus, a portion of the watermark or pseudo-watermark is visible from only one face of the sheet, whereas another portion (the portion that is not covered by the interlayer) is visible from both faces of the sheet in transmitted light.

In a particular embodiment of the invention, the interlayer includes one or more security elements selected inter alia from the following:
dyes and/or luminescent pigments and/or interference pigments and/or liquid crystal pigments, in particular in printed form or incorporated in the interlayer;
dyes and/or photochromic or thermochromic pigments, in particular in printed form or incorporated in the interlayer;
an ultraviolet absorber, in particular in coated form or incorporated in the interlayer;
a specific light-collecting material;
a diffracting structure;
a birefringent or polarizing layer;
an automatically readable tracer having specific and measurable characteristics of luminescence (e.g. fluorescence, phosphorescence), of absorbing light (e.g. ultraviolet, visible, or infrared light), of Raman activity, of magnetism, of microwave interaction, of X ray interaction, or of electrical conductivity, and any combination of such security elements with one another or with other security elements; and
an electronic device (such as an electronic chip).

The first and/or second layer may also include one or more security elements. The security element(s) may for example be selected from:
dyes and/or luminescent pigments and/or interference pigments and/or liquid crystal pigments, in particular in printed form or incorporated in the first and/or second layer;
dyes and/or photochromic or thermochromic pigments, in particular in printed form or incorporated in the first and/or second layer;
an ultraviolet absorber, in particular in coated form or incorporated in the first and/or second layer;
a specific light-collecting material;
a diffracting structure;
a birefringent or polarizing layer;
an automatically readable tracer having specific and measurable characteristics of luminescence (e.g. fluorescence, phosphorescence), of absorbing light (e.g. ultraviolet, visible, or infrared light), of Raman activity, of magnetism, of microwave interaction, of X-ray interaction, or of electrical conductivity, and any combination of such security elements with one another or with other security elements; and
an electronic device (such as an electronic chip).

The security element(s) present in one of the first and second layers or in both of the first and second layers may also be selected, inter alia, from:
a security thread, e.g. incorporated in the bulk of one of the layers or in a window, optionally including a positive or negative printed imprint, a fluorescent agent producing a metallic, goniochromatic, or holographic effect, with or without one or more portions without metal coating;
a metal-coated, goniochromatic, or holographic foil;
a layer presenting a variable optical effect based on interference pigments or on liquid crystals;
a flat security element of relatively small format such as a visible or non-visible flake, in particular a luminescent flake;
particles or agglomerates of pigment particles or dye of the Hi-Lite type, that may be visible or non-visible, and in particular that may be luminescent; and
security fibers, in particular fibers that are metal-coated, magnetic (with soft and/or hard magnetism), or capable of absorbing or being excited by ultraviolet, visible, or infrared light, and in particular light in the near infrared (NIR).

In a particular embodiment of the invention, the first and/or second fiber layer is/are provided with at least one through opening (“window”). In particular, each of the first and second layers may include at least one through opening, at last one opening of the first layer and at least one opening of the second layer being situated in register, e.g. via the interlayer, so as to create a zone in the sheet that is transparent or translucent.

In a particular embodiment of the invention, the first and/or second layer is/are tinted, the watermarks or pseudo-watermarks then appearing tinted. The term “tinted” should be understood as meaning not white.

The first and/or second layer may also be iridescent or present a mother of pearl effect, e.g. including interference pigments.

In a particular embodiment of the invention, the security element, in particular the watermarks or pseudo-watermarks, of the first and/or second layer, and the security elements of the interlayer, are placed in register.

In an example, the first and/or second fiber layer is a layer of paper having a fabric face (i.e. a face that was in contact with the fabric of the paper machine on which the paper pulp was deposited) and the fabric face is situated on the inside of the sheet. This may improve observation of the watermark or pseudo-watermark since the fabric face is smoother and thus the intensity of transmitted light is greater. Also preferably, when the interlayer is coated, extruded or laminated, it is situated on the fabric face of the first and/or second layer.

Also preferably, the first and second layers constitute respectively the recto face and the verso face of the sheet. These layers are thus the outside layers of the sheet. Nevertheless, the first layer and/or the second layer may be coated in a transparent pigmented coating, such as that described in application WO 02/20902.

In an embodiment of the invention, the first watermark or pseudo-watermark and the second watermark or the pseudo-watermark are different. For example, the first watermark or pseudo-watermark and the second watermark or pseudo-watermark may be complementary. They may be complementary in their visual effect or with reference to a concept or an image. For example, with a security document, it is possible for the first watermark or pseudo-watermark to be a national emblem on one side and for the second watermark or pseudo-watermark to be text on the other side, or with a bank note it is possible to use respectively a portrait and the value of the note.

In another embodiment of the invention, the first watermark or pseudo-watermark and the second watermark or pseudo-watermark are identical, and preferably placed in symmetrical manner. For authentication, it may be advantageous to verify that the watermarks or pseudo-watermarks are indeed identical (e.g. a person always looking in the same direction regardless of which face is observed).

In a particular embodiment of the invention, the first watermark or pseudo-watermark and the second watermark or pseudo-watermark are at least partially in register with each other.

The sheet may be a security sheet and further include some other security element such as a security thread, a hologram, security fibers, thermochromic, photochromic, or interference compounds (liquid crystals, iridescent compounds), or indeed an electronic device (such as an electronic chip).

The weight of the sheet of the invention depends on the intended application, and may for example lie in the range 80 grams per square meter (g/m²) to 150 g/m².

The invention also provides a method of fabricating said sheet. More precisely, a first layer may be formed in which a first watermark or pseudo-watermark is created, a second layer may be formed in which a second watermark or pseudo-watermark is created, and an interlayer may be placed between said first and second layers. The first and second layers may be as described above.

In particular, each of said first and second layers may be fabricated by draining a paper pulp in suspension on the fabric of a paper machine that includes screened projections and/or embossing for creating the watermarks or pseudo-watermarks. The layers may be fabricated by using two cylinder vats (cylinder molds) or by using a cylinder vat for one of the layers and a “former” for the other layer.

It is also possible to form these layers by using a flatbed fourdrinier machine, where appropriate including a plurality of beds, with the watermarks being formed using a watermarking roll. This method may be advantageous when it is desired to have a tiled watermark, i.e. a watermark that is repeated over the entire surface of the layer.

The layers may be tinted by being colored in a sizing press, so as to obtain colored watermarks or pseudo-watermarks.

In an embodiment of the invention, the interlayer is deposited by surface treatment, in particular by spraying, by a sizing press, or by coating a compound onto the inside face of said first layer and/or of said second layer. In particular, this deposit may be made on the wet fiber layers while they are being fabricated on the paper machine, or after drying.

The coating device used may be one of those already in use in the paper-making industry, e.g. an air knife coater or a curtain coater. Such devices make it possible to obtain a layer that remains sufficiently on the surface and that fits closely over the irregularities of the surface on which it is deposited.

In a particular embodiment, a polymer layer is deposited onto the first and/or second layer by extrusion and then the two layers are assembled together by being pressed (laminated), with the extruded polymer layer(s) forming the interlayer.

In another embodiment of the invention, said watermarked or pseudo-watermarked first and second layers are pasted with a compound forming the' interlayer, in particular an adhesive compound or a foam, which foam may optionally be hot-meltable.

In an embodiment of the invention, the interlayer is pasted or laminated between the first and second layers. For example, a grained polymer film is pasted between two sheets of paper.

In another embodiment of the invention, the sheet comprises:
a first fiber layer having a first watermark or pseudo-watermark;
a second fiber layer having a second watermark or pseudo-watermark; and
an interlayer formed by a first polymer layer extruded on the first fiber layer and by a second polymer layer extruded on the second fiber layer.

For example, each extruded layer may have a weight of about 20 g/m².

The extruded layers may be in direct contact or may include a (quasi)transparent film inserted between them, which film may itself include security elements or an electronic device. In general, the interlayer may comprise a plurality of layers that are themselves translucent and that have a diffusing effect. These layers may be in direct contact or they may be separated by (quasi)transparent layers that may, where appropriate, include security elements, e.g. an electronic device.

The invention also provides an article comprising a sheet as defined above.

In particular, the article may be selected from security documents, printing/writing papers, e.g. letterheads, art papers, papers for water colors or for packaging, in particular packaging for containing luxury goods.

The security document may be selected from identity documents, in particular an identity card or a passport, payment means, in particular bank notes, checks, vouchers, or purchase orders, tickets for entry to cultural or sports events, transport tickets.

The security document may also be selected from authenticity certificates, guarantee certificates, or secure packaging, in particular for medicines, electronic components, spare parts, perfumes, and secure labels.

The invention can be better understood on reading the following description of non-limiting embodiments thereof and on examining the figures of the diagrammatic and fragmentary figures of the accompanying drawings.

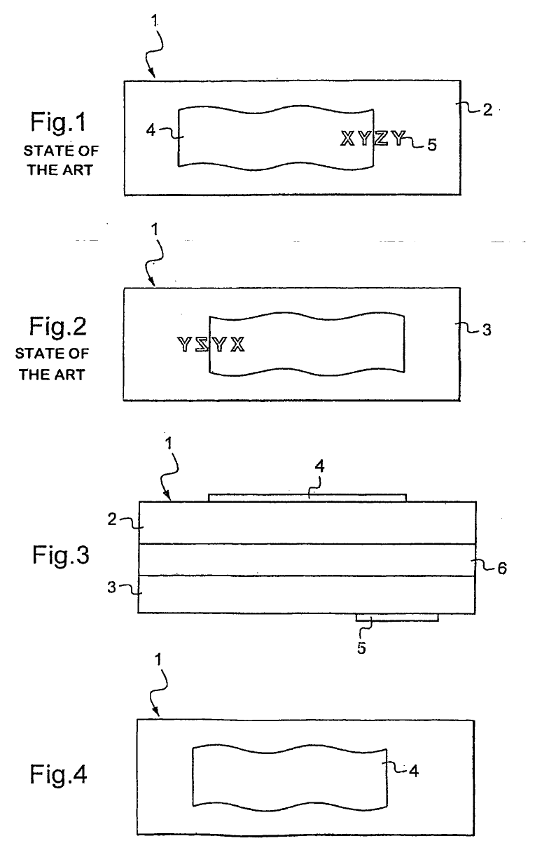

FIG. 1 shows the recto face of a sheet of the state of the art, not having an interlayer.

FIG. 2 is a view of the verso face of the FIG. 1 sheet.

FIG. 3 is a section view of a sheet of the invention, including pseudo-watermarks.

FIG. 4 is a face view of the sheets of FIGS. 3 and 6 showing their recto faces as observed in transmitted light.

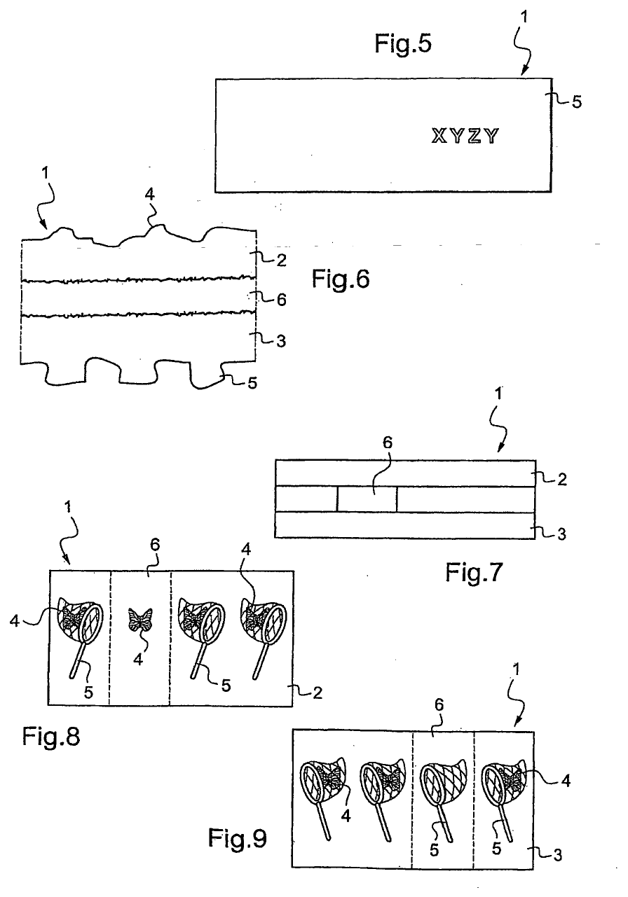

FIG. 5 is a face view of the sheets of FIGS. 3 and 6 showing their verso faces as observed in transited light.

FIG. 6 is a section view of another sheet of the invention, including watermarks.

FIG. 7 is a section view of another example of a sheet of the invention with an interlayer of small dimensions.

FIGS. 8 and 9, 10 and 11, and 12 and 13 are recto and verso face views of sheets 1 of the invention with watermarks or pseudo-markers in various positions.

FIGS. 1 and 2 are face views showing respectively the recto face and the verso face of an example sheet of the state of the art.

The sheet comprises first and second fiber or polymer layers.

The first layer may include a watermark or a pseudo-watermark, e.g. representing an emblem, and the second sheet may include another watermark or pseudo-watermark, corresponding in this example to the text “XYZY”.

The two watermarks or pseudo-watermarks are partially superposed one on the other. In a variant, they could be completely superposed one on the other or they could be disjoint, e.g. they could be one beside the other.

When the sheet in observed transmitted light, from the recto side as shown in FIG. 1 or from the verso side as shown in FIG. 2, both watermarks or pseudo-watermarks can be seen simultaneously. As a result, they can combine, e.g. to form a third pattern that results form such combination.

FIG. 3 is a section view showing an example sheet 1 of the invention.

The sheet 1 has a first layer 2 and a second layer 3 that may be as described above, together with an interlayer 6 that may have the characteristics described above, e.g. extending over the entire surface area of the first and second layers 2 and 3.

The first layer 2 and the second layer 3 include respectively a pseudo-watermark 4 and a pseudo-watermark 5, as described above, which watermarks are superposed in part one on the other. In a variant, the pseudo-watermarks 4 and 5 may be completely superposed one on the other or they may be disjoint, e.g. one beside the other.

When the sheet 1 is observed in transmitted light from beside the first layer 2 (recto side) as shown in FIG. 4, only the pseudo-watermark 4 of the first layer 2 is observed. Similarly, when the sheet 1 is observed in transmitted light from the side of the second layer 3 (verso side), as shown in FIG. 5, only the pseudo-watermark 5 of the second layer 3 is observed.

Thus, the sheet 1 of the invention makes it possible to prevent the pseudo-watermarks 4 and 5 from combining when observed in transmitted light.

FIG. 6 shows another example of a sheet 1 of the invention obtained in the manner described in detail below in Example 1.

FIG. 7 is a section view, shown diagrammatically to facilitate understanding, showing another example of a sheet 1 of the invention, having a first layer 2 and a second layer 3 that may be as described above, together with an interlayer 6.

In this example, the interlayer 6 has dimensions, in particular width, that are smaller than the dimensions of the first and second layers 2 and 3. By way of example, the interlayer 6 may correspond to a light-diffusing and translucent strip made up of one or more layers.

FIGS. 8 and 9 show respectively recto and verso sides of a sheet 1 of the invention, as may correspond to the sheet of FIG. 7.

The sheet 1 has an interlayer 6 in the form of a strip.

The first layer 2 has a plurality of watermarks or pseudo-watermarks 4, in particular a watermark or pseudo-watermark 4 that is situated entirely in register with the interlayer 6.

The second layer 3 also has a plurality of watermarks or pseudo-watermarks 5, in particular a watermark or pseudo-watermark 5 situated entirely in register with the interlayer 6.

When the sheet 1 is observed in transmitted light, it is thus possible to observe a combination of the watermarks or pseudo-watermarks 4 and 5 with each other outside the interlayer 6, as can be seen in FIGS. 8 and 9. In contrast, in register with the interlayer 6, the watermarks or pseudo-watermarks 4 and 5 do not combine.

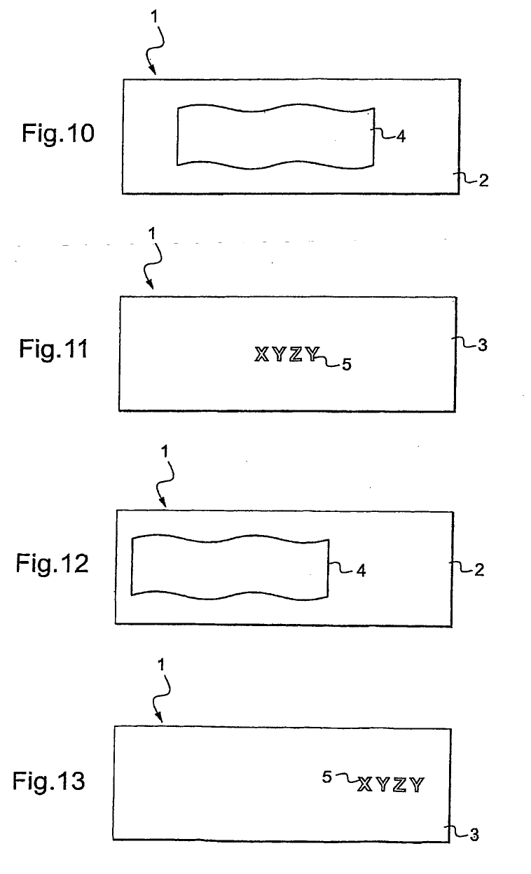

FIGS. 10 and 11 show the possibility whereby the watermark or pseudo-watermarks 4 and 5 of a sheet 1 of the invention may be totally superposed on one the other.

In this example, the sheet 1 has an interlayer (not shown) extending over the entire surface area of the first and second layers 2 and 3. From the recto side of the sheet 1, as shown in FIG. 10, only the watermark or pseudo-watermark 4 of the first layer 2 can be observed. From the verso side of the sheet 1, as shown in FIG. 11, only the watermark or pseudo-watermark 5 of the second layer 3 can be observed.

Finally, FIGS. 12 and 13 show the possibility for the watermarks or pseudo-watermarks 4 and 5 of a sheet of the invention to be disjoint. In this example the sheet 1 once more includes an interlayer (not shown) occupying the entire surface area of the sheets 2 and 3.

As above, only the watermark or pseudo-watermark 4 can be observed from the recto side of the sheet 1, as shown in FIG. 12, and only the watermark or pseudo-watermark 5 can be observed from the verso side of the sheet 1, as shown in FIG. 13.

### EXAMPLE 1

A sheet 1 of the invention of security type paper was fabricated.

A first fiber layer 2 including a watermark 4 was formed on a cylinder mold paper machine having a cylinder vat, by draining a suspension of paper pulp including cellulose fibers on the fabric of the cylinder, the watermark being formed by embossing included in the fabric, and the layer was dried. By way of example, this layer (sheet of paper) had a thickness of 100 micrometers (μm).

In the same manner, a second fiber layer 3 was formed including a watermark 5 different from the watermark 4, and it was dried. By way of example, its thickness was likewise 100 μm.

The watermarks were different, with the watermark 4 representing an emblem, for example, and the watermark 5 representing a text “XYZY”, for example.

On an extruder, a polymer layer was extruded, e.g. to present a dry weight of 20 g/m² of polyethylene (PE) on the fabric face of the (dry) first layer 2, thereby obtaining an extruded sheet having surface irregularities induced by the surface irregularities of the surface of the fiber layer. That extruded polymer layer formed the interlayer 6, with its diffusing nature coming from its surface irregularity.

The layer 2 coated in that way in a polymer layer was assembled hot in a laminator e.g. at a temperature lying in the range 90° C. to 180° C., with the (dry) fiber layer 3 by applying the extruded face of the layer 2 against the fabric face of the layer 3.

That produced a sheet 1 of the invention. On observing the sheet while facing the layer 2, the watermark 4 could be seen in transmitted light but not the watermark 5, as shown in FIG. 4; likewise the watermark 5 could be seen by observing the sheet in transmitted light only while facing the layer 3, as shown in FIG. 5.

### EXAMPLE 2

A first fiber layer was formed including a first watermark on a cylinder mold paper machine having a cylinder vat by draining a suspension of paper pulp including cellulose fibers on the fabric of the cylinder, the watermarks being formed by embossing included in the fabric, and the layer was dried.

In the same manner, as second fiber layer was formed including a second watermark different from the first, and it was dried.

On an extruder, a polymer layer, e.g. of polyethylene (PE) was extruded on the fabric face of the first layer while dry, the polymer layer matching the relief of the fiber layer. That produced an extruded sheet presenting surface irregularities.

Similarly, a polymer layer, e.g. a polyethylene layer, was extruded on the fabric face of the second layer while dry so as to obtain an extruded sheet having surface irregularities.

The two sheets coated in this way in respective polymer layers were assembled together hot, extruded face against extruded face. The two layers of extruded polymer formed an interlayer presenting a diffusing nature.

That produced a sheet of the invention. When the sheet was observed in transmitted light, only one watermark could be seen at a time, depending on the face being observed.

### EXAMPLE 3

A sheet of the invention of security type paper was formed on a flatbed fourdrinier machine having two forming beds. A suspension of paper pulp including cellulose fibers was drained on the fabric of each bed so as to form respective fiber layers each having tiled watermarks. A layer of polymer was deposited on the fabric face of one of the layers, e.g. by air-knife coating, e.g. a translucent acrylic polymer in the form of a latex (polymer in a stabilized aqueous dispersion) and presenting high viscosity, so as to form a layer on the surface of the fiber layer. Thereafter, the two layers were assembled together by pressing one against the other with the polymer layer being situated between the fiber layers so as to form said interlayer, its diffusing nature coming from its surface irregularities (induced by the irregularities of the fiber layer).

That produced a sheet of the invention on which only the watermarks of one of the layers could be seen when observing the sheet in transmitted light, depending on the face that was being observed.

### EXAMPLE 4

A first fiber layer was formed including a first watermark made in the wet portion on a paper machine.

A second fiber layer was formed including a second watermark likewise made in the wet portion on a paper machine.

The interlayer used was in the form of a light-diffusing and translucent laminating film made of thermoplastic polymer, in particular of polyethylene.

The first fiber layer, the interlayer, and the second fiber layer were assembled together hot, with moderate pressure or no pressure, in such a manner as to cause the interlayer to be sandwiched between the two fiber layers and the watermarks of the two fiber layers were superposed, for example.

That produced a sheet of the invention such that, when observed in transmitted light, the first watermark could be observed only from the first layer side and the second watermark could be observed only from the second layer side.

### EXAMPLE 5

A first layer was formed using a flexible synthetic medium, e.g. made of polyethylene, having a first mark deposited in localized manner on the outside face of the medium, e.g. a mark constituted by a layer of a composition that modifies opaqueness, and a printability layer was deposited in non-localized manner on the same face, as described in WO 91/07285, so as to obtain a synthetic medium with a first pseudo-watermark.

A second layer was formed using a flexible synthetic medium, e.g. made of polyethylene, on which a second mark was deposited in localized on the outside face of the medium, the second mark being constituted for example by a layer of opaqueness-modifying composition, and a printability layer was deposited in non-localized manner on the same face, as disclosed in WO 91/07285, so as to obtain a synthetic medium with a second pseudo-watermark.

The light-diffusing and translucent interlayer used was constituted, for example, by a polyethylene laminating film-presenting a-softening temperature lower than that of the synthetic media used for forming the first and second layers.

The first and second layers together with the interlayer were assembled together hot at the softening temperature of the laminating film, with or without pressure being applied, the printability layers being situated on the outside of the sheet, so that the interlayer was sandwiched between the first and second layers and so that the first and second pseudo-watermarks were superposed, for example.

A sheet of the invention was thus obtained such that, when observed in transmitted light, the first pseudo-watermark could be observed only from the first layer side, and the second pseudo-watermark could be observed only from the second layer side.

### EXAMPLE 6

A first fiber layer was formed including a heat-sensitive material and including a first pseudo-watermark in its thickness as taught in EP 0 203 499.

A second fiber layer was formed including a heat-sensitive material and including a second pseudo-watermark in its thickness, as taught in EP 0 203 499.

The inside faces of the first and second layers were pre-coated in a layer of pressure-sensitive transparent adhesive.

The interlayer used was in the form of a light-diffusing and translucent film, e.g. of polyethylene terephthalate.

The first fiber layer, the interlayer, and the second fiber layer were assembled together cold and under pressure so that the interlayer was sandwiched between the first and second fiber layers with the help of the pressure-sensitive adhesive layers and so that the first and second pseudo-watermarks were superposed, for example.

That produced a sheet of the invention such that, when observed in transmitted light, the first pseudo-watermark could be observed only from the first layer side, and the second pseudo-watermark could be observed only from the second layer side.

### EXAMPLE 7

On a two-jet cylinder mold paper machine, there were formed simultaneously a first fiber layer including a first watermark in the form of repeated patterns present over the entire surface of the first layer, the watermark being made in the wet portion, and a second fiber layer including a second watermark in the form of repeated patterns present over the entire surface of the second layer, the watermark being made in the wet portion.

A luminescent polycarbonate film, e.g. such as the film sold under the name Lisa® by the supplier Bayer, was pre-coated with a coating of a heat sealing varnish. Thereafter the film was cut into strips of width greater than the widths of the first and second watermarks. That produced an interlayer in the form of a strip.

The interlayer was inserted between the first and second fiber layers on the two-jet paper machine so that the interlayer in the form of a strip was situated between the two fiber layers in register with two watermarks that were themselves superposed, given that they extended over the entire areas of the layers. While the sheet was being dried, the heat-sealing varnish present on the two faces of the interlayer was reactivated, thereby enabling the interlayer to be fastened to the two fiber layers during cooling.

That provided a sheet of the invention such that, when observed in transmitted light, the first and second watermarks were both observable in combined manner on the first fiber layer side and also on the second fiber layer side, outside the strip corresponding to the interlayer. In contrast, in register with the strip, the first watermark was observable only from the first fiber layer side and the second watermark was observable only from the second fiber layer side. No combination of the watermark was possible in register with the strip, in particular because of its diffusing power.

### EXAMPLE 8

Starting from two polyethylene media including silica fillers, e.g. two films of Teslin® as sold by the supplier PPG Industries, first and second pseudo-watermarks were made on each of the media by hot embossing, as described in WO 2007/016148.

An interlayer was used in the form of a PET film pre-sized with a polyethylene and ethylene vinyl acetate (PE/EVA) adhesive on each of its faces.

The first medium with the first pseudo-watermark, the interlayer, and the second medium with the second pseudo-watermark were assembled together hot so that the interlayer was sandwiched between the two media and so that the two pseudo-watermarks were superposed, for example.

That produced a sheet of the invention such that, when observed in transmitted light, the first pseudo-watermark was observable only from the first layer side as formed by the first medium, and the second pseudo-watermark was observable only from the second layer side as formed by the second medium.

### EXAMPLE 9

First and second fiber layers were formed each having a printability layer on its surface.

An interlayer was used in the form of a light-diffusing and translucent film made of polyethylene.

The first fiber layer, the interlayer, and the second fiber layer were assembled together so that the interlayer was sandwiched between the two fiber layers.

The resulting assembly was hot-laminated, with the printability layers being situated on the outside.

Thereafter, first and second pseudo-watermarks were made on each of the printability layers, e.g. in juxtaposed manner, using the method described in WO 99/014433, i.e. by applying a re-wetting solution to each of the printability layers in the positions of the pseudo-watermarks, and then applying pressure and heat in the re-wetted zones of the printability layers so as to evaporate the solution and densify the fiber layers in these zones.

That produced a sheet of the invention such that, when observed in transmitted light, the first pseudo-watermark could be observed only from the first layer side and the second pseudo-watermark could be observed only from the second layer side.

### EXAMPLE 10

The first and second layers used were two films of polyethylene as sold under the Polyart® by the supplier Arjowiggins.

First and second pseudo-watermarks were made on each of the polyethylene films using electromagnetic radiation, e.g. laser radiation, e.g. using the method described in EP 1 518 661, i.e. by applying electromagnetic irradiation to certain zones and stretching so as to obtain transparent zones corresponding to the irradiated zones. Where appropriate, a printability layer was then applied at least on one face of each of the polyethylene films. Finally, a through opening was cut out in each of the polyethylene films, e.g. by means of a die.

An interlayer was used in the form of a light-diffusing and translucent film made of transparent polyester.

The first layer, the interlayer, and the second layer were assembled together by means of pressure-sensitive adhesives so that the interlayer was sandwiched between the two layers and so that the through openings in the first and second layers were situated in register with each other. The resulting assembly was cold-laminated, with the printability layers being situated on the outside.

That produced a sheet of the invention such that, when observed in transmitted light, the first pseudo-watermark could be observed only from the first layer side and the second pseudo-watermark could be observed only from the second layer side. The sheet obtained in that way also included a totally translucent zone corresponding to the through openings in the first and second-layers.

### EXAMPLE 11

First and second fiber layers having respective watermarks were formed on a flatbed fourdrinier machine, the watermarks being formed by means of a watermarking roller. At least one through opening was made in each of the first and second fiber layers, e.g. by laser cutting.

The interlayer used was in the form of a light-collecting patch or strip, e.g. of the “waveguide” type, e.g. a luminescent patch or strip based on polycarbonate and sold by the supplier Bayer under the name Lisa®. In a zone of the interlayer, a pattern was made by means of microperforations, e.g. a portrait, thereby revealing the “waveguide” luminescent effect of the interlayer.

The first layer, the interlayer, and the second layer were assembled together by means of an adhesive in such a manner that the interlayer was sandwiched between the two layers, in particular in register with the watermarks, and in such a manner that the zone with microperforations in the interlayer and the through openings in the first and second fiber layers were situated in register.

That produced a sheet of the invention such that, when observed in transmitted light, the first pseudo-watermark could be observed only from the first layer side in register with the interlayer in the form of a patch or a strip, and the second pseudo-watermark could be observed only from the second layer side in register with the interlayer in the form of a patch or strip. The resulting sheet also enabled the “waveguide” effect of the interlayer to be observed in register with the through openings in the first and second sheets.

The term “comprising a” should be understood as being synonymous with “comprising at least one”, unless specified to the contrary.

1-34. (canceled)

35. A sheet comprising a recto face and a verso face and at least one watermark or pseudo-watermark and such that at least part of said watermark or pseudo-watermark is observable in transmitted light from only one of the faces of said sheet.

36. A sheet according to claim 35, comprising:
a first layer including at least a first watermark or pseudo-watermark; and
a second layer including at least a second watermark or pseudo-watermark, and such that at least part of said watermark or pseudo-watermark is observable in transmitted light only from the recto face of said sheet, and at least part of said second watermark or pseudo-watermark is observable in transmitted light only from the verso face of said sheet.

37. A sheet according to claim 36, including at least one interlayer disposed between said first and second layers, and such that at least a part of said first watermark or pseudo-watermark is observable in transmitted light and in register with the interlayer only from the recto face of said sheet, and at least part of said second watermark or pseudo-watermark is observable in register with the interlayer in transmitted light only from the verso face of said sheet.

38. A sheet according to claim 37, said interlayer being light-diffusing and translucent.

39. A sheet according to claim 37, said interlayer extending over the entire surface area of said first and second layers.

40. A sheet according to claim 37, said interlayer extending in part over the surfaces of said first and second layers of the sheet, sufficiently to cover the watermarked or pseudo-watermarked portions of said layers.

41. A sheet according to claim 37, said interlayer extending over a fraction of the sheet, from one edge to the other of the sheet in a zone in register with at least one watermark or pseudo-watermark.

42. A sheet according to claim 41, said interlayer being partial and extending over only a fraction of the surface of at least one of said watermark or pseudo-watermark.

43. A sheet according to claim 37, said watermark or pseudo-watermark of the first and second layers being superposed at least in part one on the other in register with the interlayer.

44. A sheet according to claim 37, said watermarks or pseudo-watermarks being superposed one on the other in register with the interlayer.

45. A sheet according to claim 37, said interlayer being a layer including cavities.

46. A sheet according to claim 37, said interlayer being a layer including a diffusing filler selected from mineral pigments, and organic pigments.

47. A sheet according to claim 37, the interlayer presenting surface irregularities, obtained by embossing or graining the surface of the interlayer.

48. A sheet according to claim 37, said interlayer being a layer of polymer in film form.

49. A sheet according to claim 48, the interlayer being a light-collecting film.

50. A sheet according to claim 49, said interlayer being a polymer layer in the form of a film pre-bonded to the surface with an adhesive composition.

51. A sheet according to claim 37, said interlayer being a layer that is extruded, or laminated, or impregnated, or coated on the first and/or second layer(s).

52. A sheet according to claim 51, said interlayer being based on a translucent chemical compound such as dispersed polymer, or a hydrosoluble polymer, or a polymer foam.

53. A sheet according to claim 37, said interlayer being a layer of adhesive.

54. A sheet according to claim 36, said first layer and/or said second layer being fiber layers.

55. A sheet according to claim 36, said first layer and/or said second layer being polymer layers.

56. A sheet according to claim 55, the polymer layer being provided with cavities and/or mineral fillers.

57. A sheet according to claim 56, said first layer and/or second layer being based on polymer containing mineral fillers.

58. A sheet according to claim 36, said first layer and said second layer constituting respectively the recto face and the verso face of said sheet.

59. A sheet according to claim 36, said first watermark or pseudo-watermark and said second watermark or pseudo-watermark being different.

60. A sheet according to claim 36, said first watermark or pseudo-watermark and said second watermark or pseudo-watermark being complementary.

61. A sheet according to claim 36, said first watermark or pseudo-watermark and said second watermark or pseudo-watermark being identical.

62. A sheet according to claim 37, said interlayer including security elements.

63. A sheet according to claim 37, said first and second layers including security elements other than a watermark or a pseudo-watermark.

64. A sheet according to claim 63, the security element of the first and second layers and the security elements of the interlayer being placed in register.

65. An article comprising a sheet as described or fabricated in claim 35.

66. An article according to claim 65, being selected from security documents, printing/writing papers, art papers, or packaging.

67. An article according to claim 66, said security document being selected from identity documents, payment means, tickets for entry to cultural or sporting events, transport tickets.

68. An article according to claim 66, said security document being selected from authenticity certificates, guarantee certificates, or secure packaging, electronic parts, spare parts, perfumes, and secure labels.
